(19) United States
(12) Patent Application Publication
(10) Pub. No.: US 2011/0126658 A1
(43) Pub. Date: Jun. 2, 2011

(54) MANUAL GEAR SHIFT MECHANISM

(75) Inventor: Marten WITTORF, Ingelheim (DE)

(73) Assignee: GM GLOBAL TECHNOLOGY OPERATIONS, INC., Detroit, MI (US)

(21) Appl. No.: 12/956,962

(22) Filed: Nov. 30, 2010

(30) Foreign Application Priority Data
Dec. 1, 2009 (GB) 0921032.9

(51) Int. Cl. F16H 59/04; F16C 1/10

(52) U.S. Cl. 74/473.15; 74/473.21; 74/473.24

(57) ABSTRACT

In a gear shaft mechanism is provided that includes, but is not limited to a gear stick passing through slots in a plate to operate a shifter mechanism to move control cables, The gear stick is not pivotally mounted and performs only translational movements. The shaft is fixed to a bar member that is constrained to slide in a first direction relative to a frame member and the frame member is arranged to slide relative to a fixed support in a second direction. The second direction is substantially perpendicular to the first direction. A first pivot is arranged to slide on the bar member and the mechanism further includes, but is not limited to a two-armed lever pivoted at the junction of its arms to a second pivot fixed to said fixed support, a first arm of the lever being pivotally connected to the first pivot. The control cables are respectively connected to a second arm of the lever and the frame member.

### CROSS-REFERENCE TO RELATED APPLICATION

This application claims priority to British Patent Application No. 0921032.9, filed Dec. 1, 2009, which is incorporated herein by reference in its entirety.

### TECHNICAL FIELD

The technical field relates to a manual gear shifter for automotive vehicles.

### BACKGROUND

Conventional manual gear shift mechanisms comprise a gear stick or lever coupled by means of movement-translating components to one end of a dual cable arrangement. The other ends of the two cables are connected to a transmission unit comprising a plurality of gears, and the positions of the cables determine which gear is currently selected to drive the vehicle. The gear shift lever is connected to the movement-translating components via a ball joint mechanism. The gears are operated by moving the gear shift lever forwards and backwards, which produces rotation of the ball joint about a transverse axis, or from side-to-side, which produces rotation of the ball joint about a longitudinal axis. An example of such a manual gear shift mechanism is disclosed in U.S. Pat. No. 4,270,403.

A disadvantage of existing gear shifts levers is that they project a relatively long way into the interior space of the vehicle. Accordingly, it is desirable to seek to overcome, or at least reduce this above problem. In addition, it is desirable to seek to provide a manual gear shift mechanism that does not require a gear shift lever to pivot. Furthermore, other desirable features and characteristics will become apparent from the subsequent summary and detailed description, and the appended claims, taken in conjunction with the accompanying drawings and this background.

### SUMMARY

A gear shift mechanism is provided comprising a manually operated shaft which is mounted to perform substantially translational movements. An advantage of avoiding rotating movements of the gear shaft is that it can be configured to protrude less into the interior of a vehicle.

Preferably the shaft extends through a slotted opening in a substantially planar member, a manual control element being provided at one side of the planar member and a shifter mechanism being provided at the other side of the planar member. The shifter mechanism being arranged to operate two control cables of a transmission device. By suitable adaptation of the shifter mechanism, the cables can be used to control the transmission device in a known way. Thus the gear shift mechanism can be retro-fitted without requiring modifications of the transmission device.

In a preferred embodiment, the shaft is fixed to a bar member that is constrained to slide in a first direction relative to a frame member, the frame member being arranged to slide relative to a fixed support in a second direction. The second direction being substantially perpendicular to said first direction, a first pivot being arranged to slide on said bar member, the mechanism further comprising a two-armed lever pivoted at the junction of its arms to a second pivot fixed to the fixed support, a first arm of the lever being pivotally connected to the first pivot. This arrangement constitutes a convenient way of converting movements by the user of the shaft into suitable movements of the control cables.

According to a second embodiment, a gear shift mechanism is provided comprising a manually operated gear stick passing through a slotted opening to a shifter mechanism connected to the first ends of two control cables, the other ends of which are directly or indirectly connected to respective control members of a gear transmission device, wherein the stick is non-rotatably mounted.

### BRIEF DESCRIPTION OF THE DRAWINGS

The present invention will hereinafter be described in conjunction with the following drawing figures, wherein like numerals denote like elements, and:

FIG. 1 shows a diagrammatic view of a plate of a manual gear shift mechanism;

FIG. 2 shows a diagrammatic view of a selection path of movement of the mechanism of FIG. 1;

FIG. 3 shows a diagrammatic view of a shifting path of movement of the mechanism of FIG. 1;

FIG. 4 shows a diagrammatic view of the connection of the mechanism of FIG. 1 to first ends of control cables, the second ends of that are connected to a gear transmission device;

FIG. 5 shows a perspective view of a gear shift knob and plate of a manual gear shift mechanism in accordance with a first embodiment;

FIG. 6 shows a view of the combination of FIG. 5 installed in a centre-stack of a vehicle;

FIG. 7 shows a top view of the shifter mechanism provided below the combination of FIG. 5 with the mechanism in a gear select or neutral position;

FIG. 8 shows a view similar to FIG. 7 with the mechanisms moved so that other gears may be selected;

FIG. 9 shows a top view of the shifter mechanism of FIG. 7 and FIG. 8 in a gear shift position into which it has been moved so that a particular gear is engaged in the drive train of the vehicle;

FIG. 10 shows a view similar to FIG. 9 with the mechanism moved into another gear shift position so that a different gear is engaged;

FIG. 11 shows a perspective view of a manual gear shift mechanism in accordance with a second embodiment installed in a centre-stack of a vehicle;

FIG. 12 is a diagrammatic view of the connection between the mechanism of FIG. 11 and a gear transmission device of the vehicle;

FIG. 13 is a diagrammatic view of a modification of the first embodiment in a first gear shift position; and

FIG. 14 is a view similar to FIG. 13 with the mechanism in a second gear shift position.

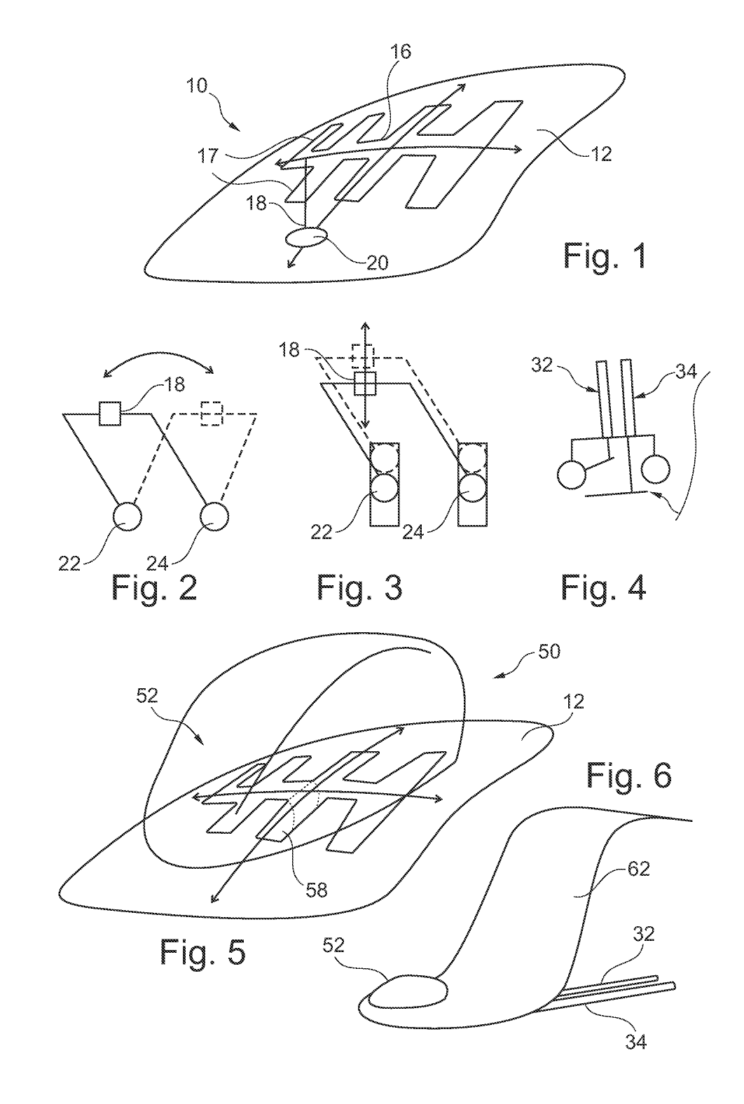

### DETAILED DESCRIPTION

The following detailed description is merely exemplary in nature and is not intended to limit application and uses. Furthermore, there is no intention to be bound by any theory presented in the preceding background or summary or the following detailed description.

In the present specification, expressions such as top, bottom, above, below, upper and lower are used merely to assist explanation and do not limit features to any particular orientation in space.

Referring to the drawings, a plate 12 of a conventional manual gear shift mechanism 10 with slots 14 extending in a fore and aft direction of the vehicle, corresponding to respective vehicle gears, and a transverse slot 16 corresponding to a neutral position in which no gear is engaged. A gear shaft or lever, indicated schematically by a line 18, moves along slots 14, 16 under the control of a knob or grip (not shown) at the top end of the shaft. At the bottom end of the shaft 18 and below plate 12, the shaft is mounted on a ball joint 20, or, as shown in FIG. 2 and FIG. 3, two ball joints 22, 24. FIG. 2 shows the shaft 18 moving along a selection path in neutral position to cause rotation of the ball joints. FIG. 3 shows the shaft 18 moving along a shift path to cause engagement of a gear. FIG. 4 represents schematically how rotation of the ball joints causes a first control cable 32 to operate a gear transmission device in one way. In addition, FIG. 4 represents how the longitudinal movement of FIG. 3 causes a second control cable 34 to operate the gear transmission device in a different way. To enable the shaft 18 to be able to move the ball joints 20, 22, 24 to their operating positions, the shaft needs to pivot to reach the ends of slots 14, 16. Thus the shaft 18 needs to project a considerable distance above plate 12.

Referring now to FIG. 5, a manual gear shift mechanism 50 in accordance with a first embodiment comprises a knob 52 which moves over the top surface of a plate 12 to constitute a gear selector. The knob is mounted at the top of a shaft 58 which extends through slots 14 or 16 in the plate. Instead of pivoting in use, shaft 58 is arranged to project substantially vertically downwardly through slots 14, 16 at all times so that knob 52 can travel on or closely above the top surface of plate 12. The movements of knob 52 are thus translational movements and not pivotal movements.

FIG. 6 shows the knob 52 of FIG. 5 located so as to be mounted above a centre-stack 62 of a vehicle. The two cables 32, 34 to be operated by the gear shift mechanism 50 are also shown in FIG. 6.

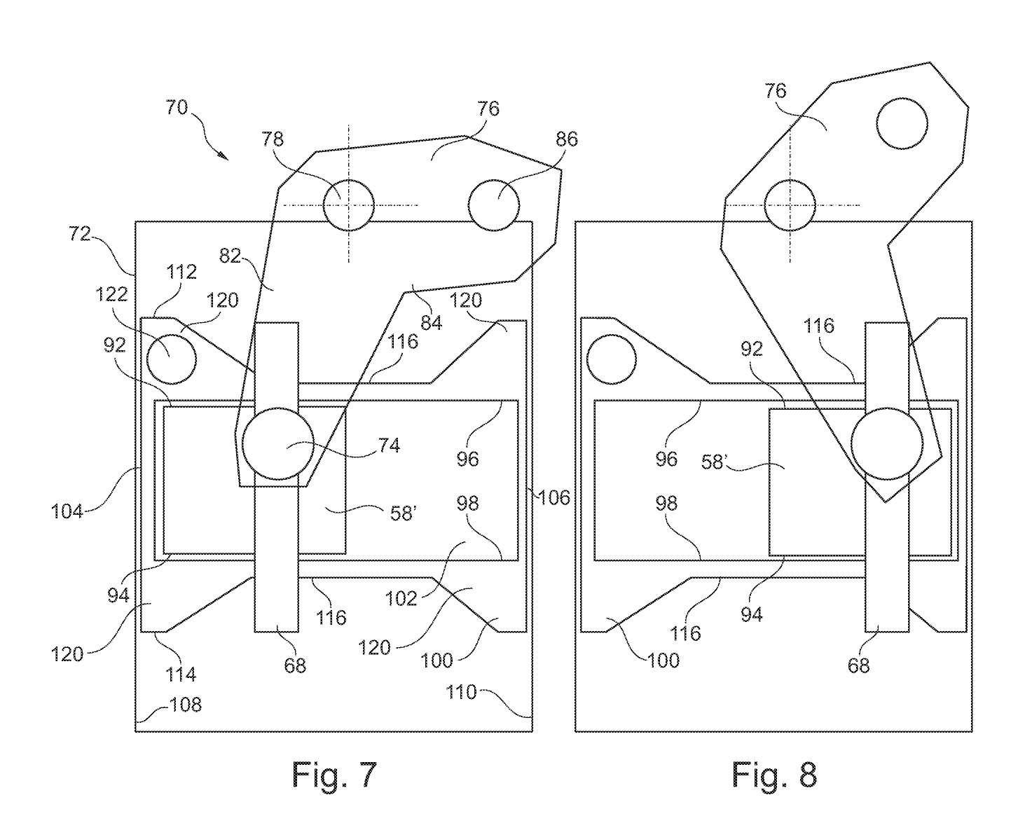

FIG. 7 shows a shifter mechanism 70 located below the plate 12 in FIG. 5 and arranged to translate the movements of shaft 58 into movement of the cables 32, 34. The shifter mechanism is arranged within a fixed housing 72 inside which moves the bottom end of shaft 58 attach to a block 58′. A bar member 68 is fixed to the block 58′ and a pivot 74 is attached to bar member 68 to slide there along. A flat lever element 76 pivots around a fixed pivot 78 which is fixedly mounted on housing 72. The end of one arm 82 of the lever element is rotatably attached to pivot 74. At the end of another arm 84 of the lever element there is provided a hole 86 for the connection of the select cable 32.

The sides 92, 94 of block 58′ are arranged to slide on opposed internal sides 96, 98 of a rectangular aperture 102 formed in a shift frame 100, which extends across substantially the entire width of housing 72. Frame 100 has external sides 104, 106 which are arranged to slide on opposed internal sides 108, 110 of the housing 72. The other external sides 112, 114 of frame 100 are each formed with a recessed edge 116 arranged between corner projections 120. The major surface of bar member 68 not visible in FIG. 7 is provided with formations which allow the bar member to slide along the edges 116. The length of the edges 116 corresponds substantially to the maximum possible range of movement of block 58′ along aperture 102. One of the corner projections 120 is provided with a hole 122 for the connection of the shift cable 34.

The way in which shifter mechanism 50 operates will now be described. FIG. 7 shows the mechanism in a neutral or selection position with the mechanism ready to select certain gears. In FIG. 8, shaft 58 has moved to the opposite end of slot 16 so that the mechanism is ready to select other gears. During this movement edges 92, 94 have slid along respective sides 96, 98 and the formations on bar member 68 have slid along respective edges 116. Frame 100 has remained in the same position, but lever element 76 has been pivoted so that select cable 32 has been moved.

It will be appreciated that movement of shaft 58 between the position of FIG. 7 and FIG. 8 correspond to side-to-side movements of knob 52. When used in connection with plate 12, there will also be two operative intermediate positions substantially equally-spaced between the positions of FIG. 7 and FIG. 8 and corresponding to the inner two slots 14. In these intermediate positions, the mechanism is ready to select respective further gears.

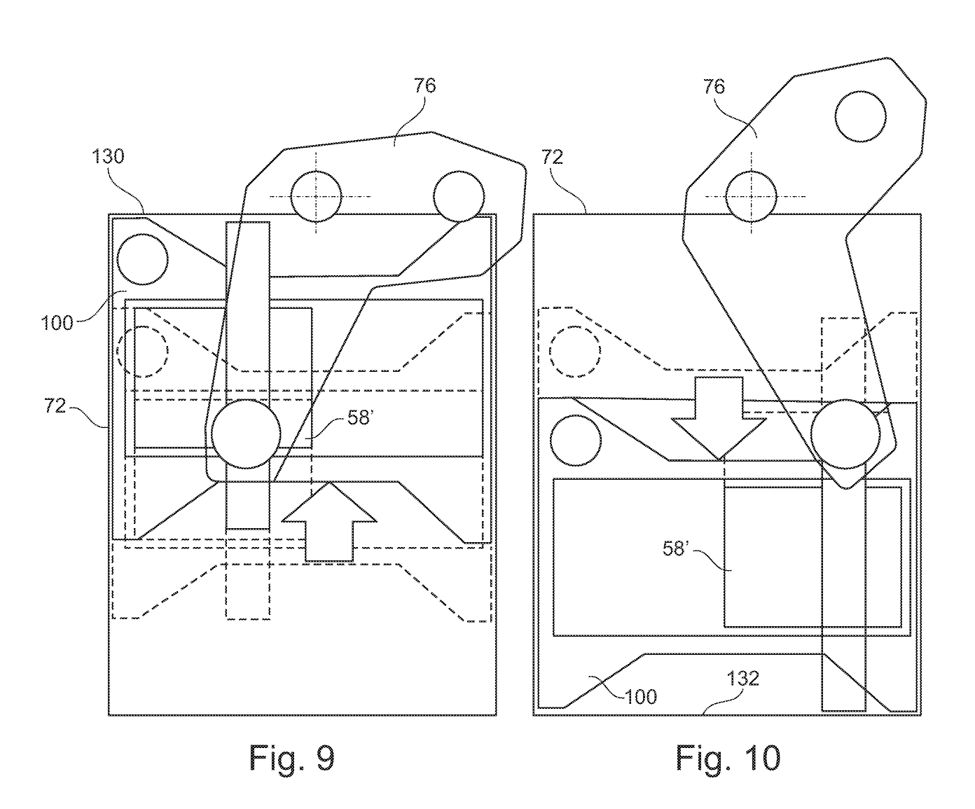

In FIG. 9, shaft 58 has been moved along a slot 14 in plate 12 so that, compared to FIG. 7, frame 100 has been moved towards an end 130 of housing 72. The FIG. 7 position is shown in broken lines. Thus edges 104, 106 have slid along respective edges 108, 110. At the same time, pivot 74 has slid along bar member 68 so that the pivotal position of lever element 76 has not changed as compared to FIG. 7, and thus the position of cable 32 has not changed. By virtue of the connection of cable 34 to hole 122 in frame 100, this cable has been moved so as to engage a gear in the transmission device at its other end.

FIG. 10 shows the frame 100 moved towards the opposite end 132 of the housing 72. The FIG. 8 position is shown in broken lines and it will be noted that the pivotal position of lever element 76 has not changed, and thus the position of cable 32 has not changed as compared to FIG. 8. However, the movement of frame 100 has been produced a different movement of cable 34. It will be appreciated that the movements between FIG. 7, FIG. 9 and FIG. 10 correspond to fore and aft movements of knob 52 and shaft 58. Thus it will be appreciated that the shift mechanism 50 provides a convenient way to enable the translational movements of knob 52 to be converted into operational movement of control cables 32, 34. By permitting movements of knob 52 which are co-planar, or at least substantially co-planar, the length of shaft 58 projecting above plate 12 can be kept to a minimum. In fact the spacing can be effectively zero so that knob 52 slides on the upper surface of plate 12. This leads to a saving of space, and the inconvenience of a length of shaft 58 projecting into the interior of the vehicle is avoided. Accordingly the driver and other users of the vehicle enjoy a greater degree of freedom of movement without snagging the gear controls. In addition, the compact design has a pleasing appearance. Since the knob 52 substantially covers the plate 12 and conceals shaft 58 it gives the appearance of hovering or floating unsupported over the plate. Moreover, it gives freedom of design to other aspects of a vehicle.

No modifications are needed to the gear transmission device at the other end of the cables 32, 34. Various modifications can be made to the above-described embodiment. For example the plate 12 may be slightly curved transversely and/or longitudinally. The shifter mechanism 70 still operates in the same way, but the surface contour of plate 12 may be adapted to control the dynamic operation of the shifter mechanism. The shapes and relative sizes of the components of shifter mechanism may be selected as desired. Hole 86 can be provided at any convenient location along lever arm 84, and hole 122 can be provided at any convenient location on frame 100. A plurality of holes 86 can be provided to give additional options for the cable transmission ratio when retro-fitting the gear select mechanism. Housing 72 can be replaced by any suitable fixed support, provided it still has the required slide surfaces.

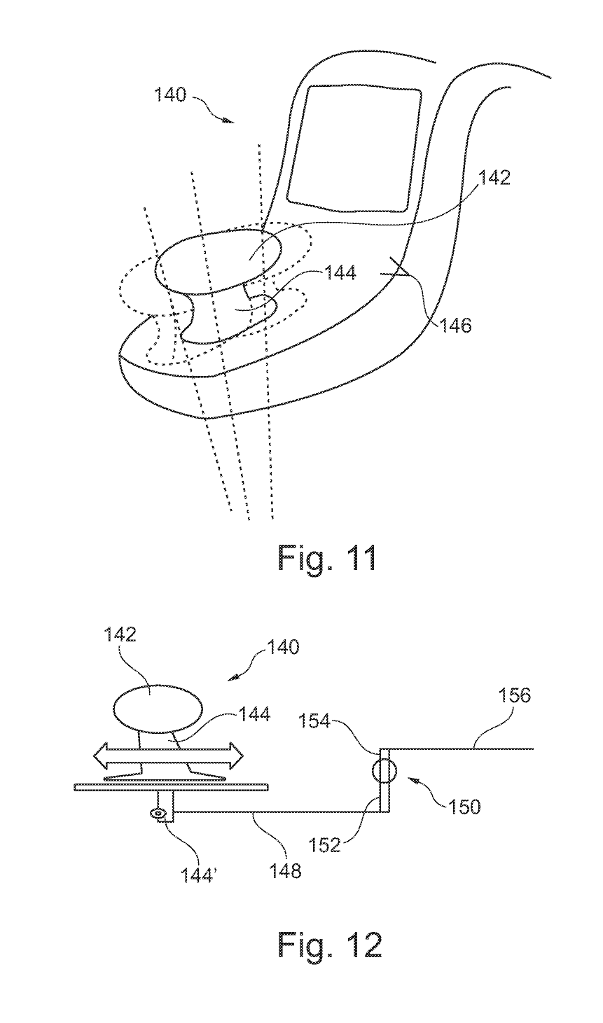

FIG. 11 and FIG. 12 show a manual gear shift mechanism 140 in accordance with a second embodiment. A shifter grip 142 mounted on an integral shaft 144 is moveable over the surface of a center-stack 146. The shape and position of grip 142 are ergonomically suited to a driver's hand. The bottom end 144′ of shaft 144 is connected by means of a shifter mechanism (not shown) to control cables for a gear transmission device. One of these cables is shown at 148 in FIG. 12 as being connected to a fixed arm 152 of a pivotal linkage 150 connected to the center-stack 146. The other arm 154 of the pivotal linkage is connected via a cable 156 to the gear transmission device. The use of the linkage 150 has the advantage of permitting adjustment of the cable transmission ratio between the grip 142 and the transmission device, enabling the gear shift mechanism 140 to be retro-fitted. The same modification may also be made to the first embodiment.

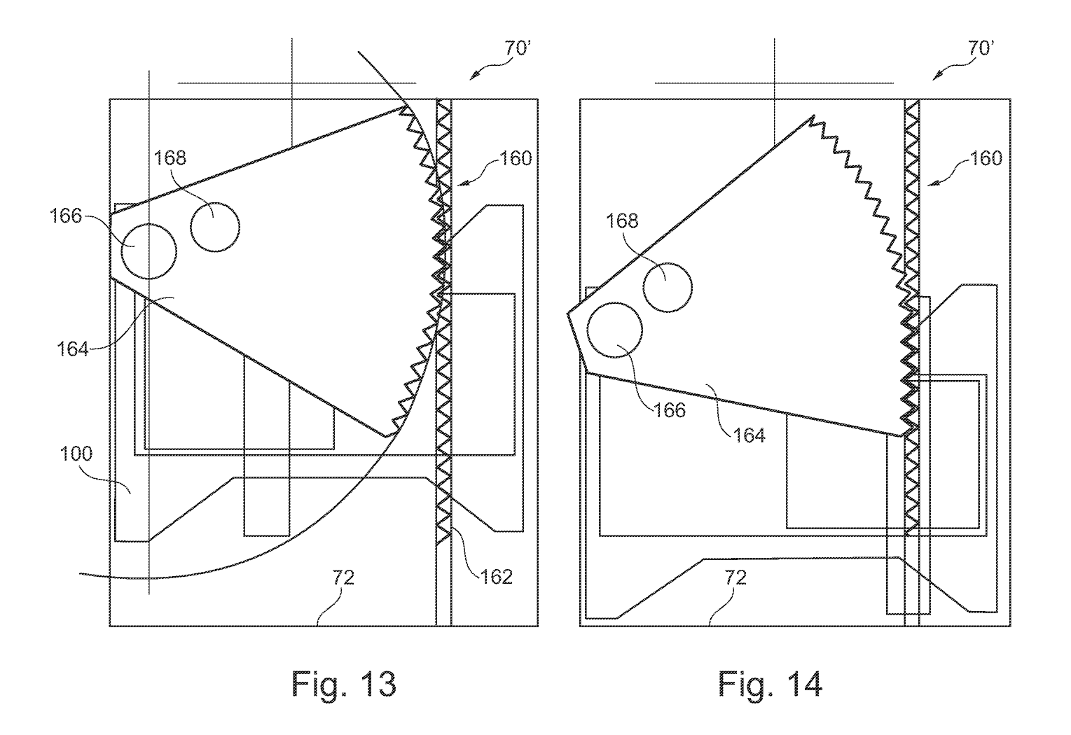

FIG. 13 and FIG. 14 show a modification 70′ of the shifter mechanism 70 of FIG. 7 to FIG. 10 in that a toothed rack-and-pinion mechanism 160 is provided. A fixed toothed element 162 is fixedly attached to a housing 72. A toothed segment 164 is pivotally attached at pivot 168 to frame 100, e.g. adjacent the position of hole 122. Segment 164 has a hole 166 to which cable 34 is attached instead of to hole 122. This enables the cable transmission ratio to be varied between the knob 52 and the transmission device, making the modified gear shaft mechanism easier to retro-fit. The toothed elements may be replaced by any other suitable gearing mechanism between frame 100 and the cable 34. This modification, together with the other medications mentioned in connection with the first embodiment, may also be made to the second embodiment. The various transmission ratio adjusting devices can be used alone or in combination on the cables as appropriate. The shift mechanism may be arranged at locations other than in a centre-stack; for example they can be in a console.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A gear shift mechanism, comprising:
a manually operated shaft; and
a mounting for the manually operated shaft,
wherein the manually operated shaft is mounted with the mounting to perform a substantially translational movement.

2. The gear shift mechanism according to claim 1, further comprising:
a substantially planar member;
a slotted opening adapted to receive the manually operated shaft;
a manual control element at a first side of a planar member; and
a shifter mechanism at a second side of the planar member, said shifter mechanism arranged to operate two control cables of a transmission device.

3. The gear shift mechanism according to claim 1,
wherein the manually operated shaft is fixed to a bar member and constrained to slide in a first direction that is relative to a frame member,
wherein the frame member is arranged to slide relative to a fixed support in a second direction that is substantially perpendicular to said first direction,
wherein a first pivot is arranged to slide on said bar member,
wherein the gear shift mechanism further comprising a two-armed lever pivoted at a junction of a first arm and a second arm of the two-armed lever to a second pivot fixed to said fixed support, and
wherein the first arm is pivotally connected to said first pivot.

4. The gear shift mechanism according to claim 3,
wherein the second arm of the two-armed lever is arranged for connection to a first control cable, and
the frame member is arranged for connection to a second control cable.

5. The gear shift mechanism according to claim 3, wherein said manually operated shaft extends in a direction that is substantially perpendicular to both said first direction and said second direction.

6. The gear shift mechanism according to claim 1, further comprising:
a control cable;
a frame member;
a gearing mechanism that is connected to the frame member; and
a driven element of the gearing mechanism arranged for connection to the control cable.

7. The gear shift mechanism according to claim 1, further comprising:
a frame member;
a gearing mechanism that is connected to the frame member, the gearing mechanism comprising:
a fixed support;
a toothed element fixed to the fixed support; and
a driven element in a form of a rotational toothed element that is arranged to pivot on the frame member and has teeth engaging the teeth of a fixed toothed element.

8. The gear shift mechanism according to claim 6, wherein a second arm of a two-armed lever is connected via an intermediate cable to a first linkage arm of a pivotal linkage member and a third arm arranged for connection to the control cable.

9. The gear shift mechanism according to claim 3, wherein the frame member is connected via an intermediate cable to a first linkage arm of a pivotal linkage member and a second linkage arm is arranged for connection to a respective control cable.

10. A gear shift mechanism, comprising:
a first control cable;
a second control cable;
a shifter mechanism;
a slotted opening;
a manually operated gear stick that is non-rotatably mounted and passes through the slotted opening to the shifter mechanism connected to a first end of the first control cable and the second control cable, and a second end of the first control cable and the second control cable connected to a first control member and a second control member of a gear transmission device.

11. The gear shift mechanism according to claim 10, wherein the second end of the first control cable and the second control cable are directly connected to the first control member and the second control member.

12. The gear shift mechanism according to claim 10,
wherein the slotted opening comprises a plurality of slots defining a respective configuration of the gear transmission device, and
wherein the shifter mechanism comprises a corresponding number of configurations determining different positions of the first control cable and the second control cable.

13. The gear shift mechanism according to claim 10,
wherein the manually operated gear stick is fixed to a bar member that is constrained to slide in a first direction relative to a frame member,
wherein the frame member is arranged to slide relative to a fixed support in a second direction, said second direction substantially perpendicular to said first direction,
wherein a first pivot is arranged to slide on said bar member, and
wherein the gear shift mechanism further comprises a two-armed lever pivoted at a junction of a first arm and a second arm to a second pivot fixed to said fixed support, the first arm pivotally connected to said first pivot and the second arm connected to the first end of the first control cable and with the frame member connected to the first end of the second control cable.

14. The gear shift mechanism according to claim 13, further comprising:
a gearing mechanism connected to the frame member; and
a driven element arranged for connection to a control cable.

15. The gear shift mechanism according to claim 13, further comprising:
a toothed element fixed to the fixed support; and
a driven element in a form of a rotational toothed element that is arranged to pivot on said frame member and comprises teeth engaging the teeth of a fixed toothed element.

16. The gear shift mechanism according to claim 13, wherein the second arm of the two-armed lever is connected via an intermediate cable to a first linkage arm of a pivotal linkage member and a second linkage arm is arranged for connection to a control cable.

17. The gear shift mechanism according to claim 13, wherein the frame member is connected via an intermediate cable to a first linkage arm of a pivotal linkage member and a second linkage arm is arranged for connection to a control cable.
